(19) United States
(12) Patent Application Publication
(10) Pub. No.: US 2024/0351174 A1
(43) Pub. Date: Oct. 24, 2024

(54) MAGNET FASTENER, ROTARY DRIVER AND METHOD OF ASSEMBLING THE SAME

(71) Applicant: MILWAUKEE ELECTRIC TOOL CORPORATION, Brookfield, WI (US)

(72) Inventors: Ben Zhen JIANG, Anderson, SC (US); Jian Wei HUANG, Anderson, SC (US)

(21) Appl. No.: 18/639,265

(22) Filed: Apr. 18, 2024

(30) Foreign Application Priority Data
Apr. 18, 2023 (CN) 202310416787.9

(51) Int. Cl. B25B 23/12; B23B 51/12; B25B 23/00

(52) U.S. Cl. CPC B25B 23/12; B23B 51/12; B25B 23/0035

(57) ABSTRACT

The present invention provides a magnet fastener, a rotary drive and an assembly method thereof. The magnet fastener includes a deformable section, an accommodation section for accommodating a magnet, and a blocking mechanism in sequence from the rear side to the front side, the blocking mechanism blocks the magnet from detaching from the front side, and the deformable section deforms radially outward when subjected to an axial force. The rotary drive includes the magnet fastener, a magnet located in the accommodation section, and a sleeve for accommodating the fastener, the inner periphery of the sleeve is provided with an annular groove, and the deformable section deforms radially outward to snap into the annular groove when subjected to an axial force, so that the fastener can be locked within the sleeve.

### FIELD OF THE INVENTION

The present invention relates to the field of rotary drives, particularly to a magnet fastener. The invention also relates to a rotary drive and an assembly method thereof.

### BACKGROUND OF THE INVENTION

Magnets are widely used in rotary drives, such as nut drives, bolt drives or drill bit drives, etc., to magnetically attract and fix the rotated nuts, bolts or drill bits. In the prior art, the magnet block is either directly pressed into the hole of the rotary drive, or is stuck in the hole of the rotary drive through an adhesive, or is fixed by placing soft materials such as aluminum/copper between the magnet block and the hole of the rotary drive. However, with the above fixation methods, the magnet block tends to fall off from the rotary drive after being used for a period of time.

In addition, in the prior art, mechanical fasteners are also used to fix the magnet to the main object. It is well known that the magnetic attraction force between a magnet and a magnetically attracted object is inversely proportional to the distance therebetween. Many magnet fasteners in the prior art render an unwanted gap generated between the magnet and the magnetically attracted object.

Therefore, there is a need to provide a magnet fastener, a rotary drive and an assembly method thereof to at least partially solve the above problems.

### SUMMARY OF THE INVENTION

The aim of the present invention is to provide a magnet fastener, a rotary drive and an assembly method thereof. The magnet fastener of the present invention comprises a deformable section, an accommodation section for accommodating a magnet, and a blocking mechanism in sequence from the rear side to the front side, wherein the blocking mechanism blocks the magnet from detaching from the front side, and the deformable section deforms radially outward when subjected to an axial force. The rotary drive of the present invention comprises the magnet fastener as described above, a magnet located in the accommodation section, and a sleeve for accommodating the fastener, wherein the inner periphery of the sleeve is provided with an annular groove, and the deformable section deforms radially outward to snap into the annular groove when subjected to an axial force. In addition, the outer periphery of the fastener of the present invention is further provided with an annular deformable groove between the deformable section and the accommodation section. The annular deformable groove deforms radially inward when subjected to a force, which snaps the magnet, and prevents it from moving backwards. Furthermore, the present invention avoids the problem that a gap is generated between the magnet and a magnetically attracted object, through the structural matching design of the blocking mechanism and the magnet which makes the front end surface of the magnet flush with the front end surface of the fastener.

According to one aspect of the present invention, there is provided a magnet fastener, which comprises a deformable section, an accommodation section for accommodating a magnet, and a blocking mechanism in sequence from the rear side to the front side, wherein the blocking mechanism blocks the magnet from detaching from the front side, and the deformable section deforms radially outward when subjected to an axial force.

In an embodiment, the deformable section has an axial cross-section of U-shaped, V-shaped or C-shaped structure with an opening facing the central axis.

In an embodiment, the deformable section includes a first deformable section, a second deformable section and a third deformable section which are connected in sequence, wherein the front side of the first deformable section is connected to the accommodation section.

In an embodiment, the inner diameter of the second deformable section is larger than the inner diameter of the accommodation section, and the inner diameter of the first deformable section gradually decreases from the second deformable section to the accommodation section; and the inner diameter of the third deformable section is smaller than the inner diameter of the second deformable section and is greater than or equal to the inner diameter of the accommodation section.

In an embodiment, the fastener is made of a material which is a soft material, preferably aluminum, copper or plastic.

In an embodiment, the outer periphery of the fastener is provided with an annular deformable groove between the deformable section and the accommodation section, and the annular deformable groove deforms radially inward to fix the magnet when subjected to an axial force.

In an embodiment, the depth of the annular deformable groove is approximately half of the wall thickness of the accommodation section.

In an embodiment, the blocking mechanism is an annular inner chamfer structure.

In an embodiment, the blocking mechanism is an annular flange structure, and the inner diameter of the annular flange is smaller than the inner diameter of the accommodation section and the maximum diameter of the magnet.

In an embodiment, the outer periphery of the fastener is provided with a strip-shaped convex structure.

According to another aspect of the present invention, there is provided a rotary drive which comprises the magnet fastener as described above, a magnet located in the accommodation section, and a sleeve for accommodating the fastener, wherein the inner periphery of the sleeve is provided with an annular groove, and the deformable section deforms radially outward to snap into the annular groove when subjected to an axial force.

In an embodiment, the inner periphery of the sleeve is provided with an annular slope behind the annular groove, and the annular slope inclines from outside to inside in a direction away from the annular groove.

In an embodiment, the rear end of the deformable section is provided with an annular chamfer, and the angle of the annular chamfer is less than or equal to the angle of the annular slope before the deformable section is subjected to an axial force.

In an embodiment, the outer periphery structure of the front end of the magnet coincides with the blocking mechanism.

In an embodiment, the front end surface of the magnet is flush with the front end surface of the fastener.

In an embodiment, the fastener is provided with a step at the outer periphery thereof between the blocking mechanism and the accommodation section.

In an embodiment, the inner periphery of the front side of the sleeve is provided with a slot for driving a rotary object to rotate.

In an embodiment, the rotary object is a nut, a bolt or a drill bit.

In an embodiment, the rear side of the sleeve is provided with a driving connection part for connecting with a driving mechanism.

In an embodiment, the rotary drive is a socket wrench.

According to yet another aspect of the present invention, there is provided a method for assembling a rotary drive, the rotary drive comprising a fastener, a sleeve and a magnet, the fastener being provided with a deformable section and an accommodation section, the inner periphery of the sleeve being provided with an annular groove, the method comprising the following steps:
inserting the magnet from the rear side of the fastener and fixedly installing it into the accommodation section;
inserting the fastener from the front side of the sleeve;
applying an axial force to the fastener and pushing the fastener to the rear end inside the sleeve;
further applying an axial force to the fastener, such that the deformable section is deformed radially outward under the axial force and snaps into the annular groove.

In an embodiment, the fixed installation is achieved by interference fit, adhesive or the way of placing soft material between the magnet and the accommodation section.

In an embodiment, the outer periphery of the fastener is further provided with an annular deformable groove between the deformable section and the accommodation section.

In an embodiment, further applying an axial force to the fastener is such that the deformable section is deformed radially outward under the axial force and snaps into the annular groove, and meanwhile such that the annular deformable groove is deformed radially inward under the axial force to fix the magnet.

### BRIEF DESCRIPTION OF THE DRAWINGS

For a better understanding of the above and other objects, features, advantages and functions of the present invention, reference may be made to the preferred embodiments illustrated in the accompanying drawings. Same reference numbers in the drawings refer to same components. It should be understood by those skilled in the art that the accompanying drawings are intended to schematically illustrate preferred embodiments of the present invention without any limitation on the scope of the present invention, and the various components in the drawings are not drawn to scale.

FIG. 1 is a cross-sectional view of a magnet fastener according to a preferred embodiment of the present invention (the deformable section is not subjected to an axial force);

FIG. 2 is a perspective view of a magnet fastener according to a preferred embodiment of the present invention (the deformable section is not subjected to an axial force);

FIG. 3 is a partial cross-sectional view of a rotary drive according to a preferred embodiment of the present invention (the deformable section is not subjected to an axial force);

FIG. 4 is a partial cross-sectional view of a rotary drive according to a preferred embodiment of the present invention (the deformable section is radially deformed by an axial force);

FIG. 5 is an overall perspective view of a rotary drive according to a preferred embodiment of the present invention;

FIG. 6 is an overall cross-sectional view of a rotary drive according to a preferred embodiment of the present invention (the deformable section is radially deformed by an axial force).

### REFERENCE NUMBER

1 fastener
11 deformable section
111 first deformable section
111′ outer deformable portion
112 second deformable section
113 third deformable section
12 accommodation section
13 blocking mechanism
14 annular chamfer
15 annular deformable groove
15′ inner deformable portion
16 convex structure
17 step
2 sleeve
21 annular groove
22 annular slope
23 slot
24 driving connection part
3 magnet
4 central axis

### DETAILED DESCRIPTION

Specific embodiments of the present invention will now be described in detail with reference to the accompanying drawings. The contents described herein is only the preferred embodiment according to the present invention. Those skilled in the art can envisage other approaches to implement the present invention based on the preferred embodiment, and the other approaches also fall within the scope of the present invention.

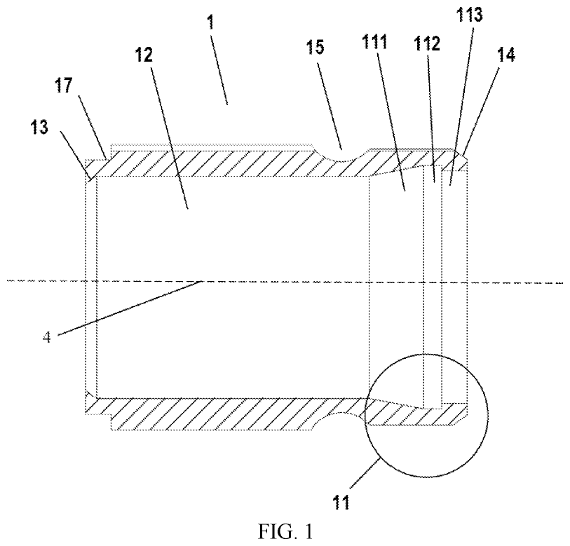

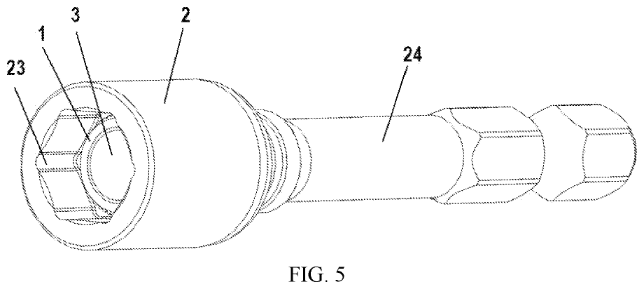

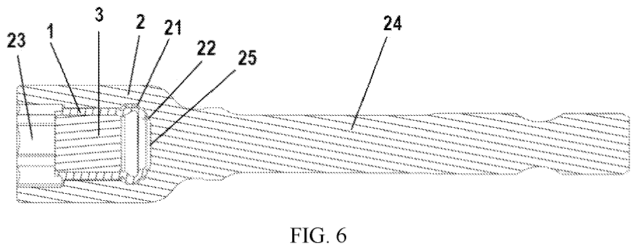

FIGS. 1-6 show a magnet fastener and a rotary drive according to the invention. First of all, it should be noted that the direction terms and position terms in the present invention should be understood as relative directions and positions, rather than absolute directions and positions. The direction terms and position terms in the present invention can be explained with reference to the exemplary structures shown in FIGS. 1 to 6. For convenience, the left side in the figures is defined as the “front side” and the right side is defined as the “rear side”.

In the prior rotary drives, the magnet block is either directly pressed into the hole of the rotary drive, or is stuck in the hole of the rotary drive through an adhesive, or is fixed by placing soft materials such as aluminum/copper between the magnet and the hole of the rotary drive. However, with the above fixation methods, the magnet tends to fall off from the rotary drive after being used for a period of time.

In a first aspect of the present invention, there is provided a magnet fastener that can avoid the above problems. With reference to FIGS. 1-4, according to a preferred embodiment of the magnet fastener of the present invention, the fastener 1 comprises a deformable section 11, an accommodation section 12 for accommodating a magnet, and a blocking mechanism 13 in sequence from the rear side to the front side, wherein the blocking mechanism 13 blocks the magnet from detaching from the front side, and the deformable section 11 deforms radially outward when subjected to an axial (front-rear direction) force.

It should be noted that the structure and material of the deformable section 11 are not particularly limited, as long as it can deform radially outward when subjected to axial (front-rear direction) force. The deformable section 11 may be formed by reducing portions of material. For example, the structure of the deformable section 11 can be a general groove structure. For example, the axial cross-section of the deformable section is of a U-shaped, V-shaped or C-shaped structure with an opening facing the central axis 4. When subjected to an axial force, the U-shaped, V-shaped or C-shaped structure can deform (protrude) radially outward to become a convex structure.

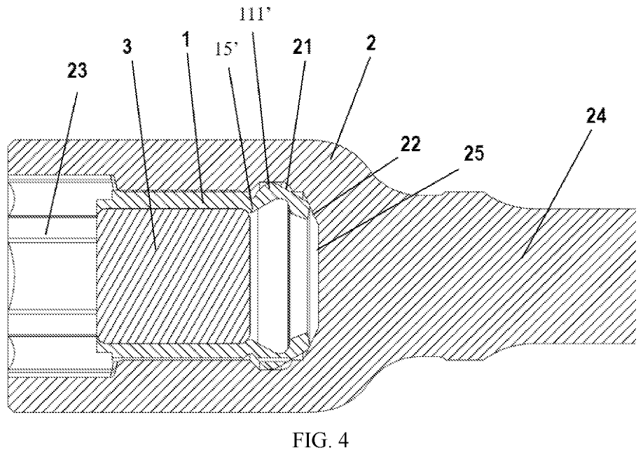

In an embodiment of the present invention, as shown in FIG. 1, the deformable section 11 includes a first deformable section 111, a second deformable section 112 and a third deformable section 113 which are connected in sequence, wherein the front side of the first deformable section 111 is connected to the accommodation section 12. Among others, the inner diameter of the second deformable section 112 is larger than the inner diameter of the accommodation section 12, and the inner diameter of the first deformable section 111 gradually decreases from the second deformable section 112 to the accommodation section 12; and the inner diameter of the third deformable section 113 is smaller than the inner diameter of the second deformable section 112 and is greater than or equal to the inner diameter of the accommodation section 12. This design enables the deformable section 11 to form an outer deformable portion 111′ after being stressed in the axial direction, and thereby form a “barb-like structure” as shown in FIG. 4 (after deformation, the flange formed by the front and rear slopes of the deformable section 11 inclines forwards as a whole). The outer deformable portion 111′ is fitted with the annular groove 21 of the sleeve 2, thereby fixing the fastener 1 in the sleeve 2.

In order to achieve the function of the deformable section 11 being able to deform after being subjected to an axial force, at least part of the material of the deformable section 11 is selected from soft materials. For ease of production, as a preferred example, the fastener 1 is made of a single soft material. In addition, it is also necessary to ensure that the deformable section 11 can maintain a certain shape after being deformed by force, so that it can be snapped into and fixed in the annular groove 21 for a long time. For this, in a preferred embodiment of the present invention, the material of the fastener 1 is one of aluminum, copper or plastic.

In addition, as shown in FIG. 1, an accommodation section 12 is provided on the front side of the fastener 1 for accommodating the magnet 3. As a preferred embodiment, the accommodation section 12 has a cavity structure with the same shape as the magnet 3. Preferably, the both have a cylindrical structure. The inner diameter of the accommodation section 12 is configured to accommodate the magnet. As mentioned above, the inner diameter of the third deformable section 113 is smaller than the inner diameter of the second deformable section 112 and is greater than or equal to the inner diameter of the accommodation section 12. This design allows the magnet 3 to be placed into the accommodation section 12 from the rear side of the fastener 1.

As further shown in FIG. 1, a blocking mechanism 13 is provided at the front end of the fastener 1 to block the magnet 3 from detaching from the front side of the fastener 1. It should be noted that the present invention is not limited to the specific mode of the blocking mechanism 13, as long as it can block the magnet 3 from moving forward. As an example, the blocking mechanism 13 is an annular inner chamfer structure (i.e., the structure shown in FIG. 1) to hold the magnet 3 in the accommodation section 12. As another preferred example, the blocking mechanism 13 is an annular flange structure, and the inner diameter of the annular flange is smaller than the inner diameter of the accommodation section 12 and the maximum diameter of the magnet 3.

It should be noted that, as shown in FIG. 1, in actual use, the front side of the fastener 1 is used for magnetically attracting rotary objects, such as nuts, bolts or drill bits. The blocking mechanism 13 also has a blocking effect on the rotary object, thereby preventing the rotary object from exerting a backward force on the magnet 3. Therefore, the magnet 3 is mainly subjected to a forward force (the rotary object provides the magnet 3 with a forward magnetic attraction force), with relatively little or no backward force. In this regard, on the one hand, the magnet 3 can be designed as a cylinder, and the diameter thereof is slightly larger than the inner diameter of the accommodation section 12, so that there is an interference fit between the magnet 3 and the accommodation section 12 to fix the magnet 3 and prevent it from moving backwards and away from the rotary object; on the other hand, an adhesive can be used to stick the magnet 3 in the accommodation section 12, or a soft material such as aluminum/copper can be placed between the magnet 3 and the accommodation section 12 for fixation.

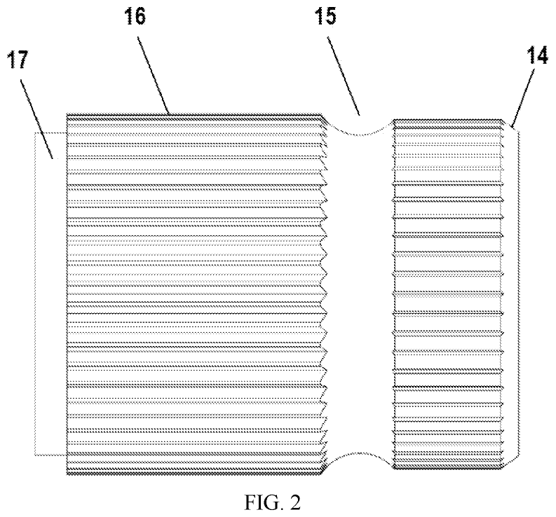

As a preferred embodiment of the present invention, with reference to FIGS. 1 and 2, an annular deformable groove 15 is provided on the outer periphery of the fastener 1 at a suitable position between the deformable section 11 and the accommodation section 12, and the annular deformable groove 15 deforms radially inward when subjected to an axial force, forming an inner deformable portion 15′, which blocks the magnet 3 and prevents the magnet 3 from moving backwards in a more secure manner. As a preferred example, the depth of the annular deformable groove 15 is approximately half of the wall thickness of the accommodation section 12.

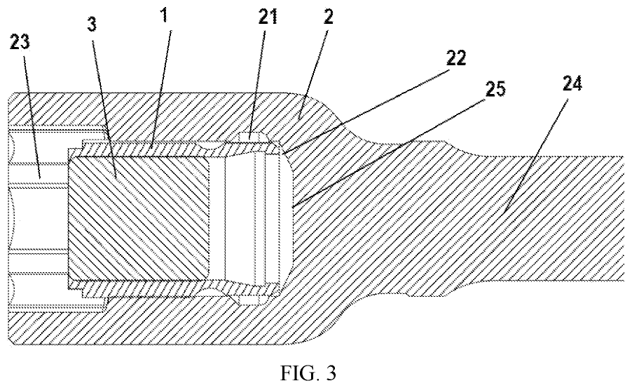

It should be emphasized that, as shown in FIGS. 3 and 4, when the fastener 1 is subjected to an axial force, the annular deformable groove 15 provided on the front side of the deformable section 11 also helps to make the deformable section 11 deform radially outward.

In a second aspect of the present invention, there is provided a rotary drive. In a preferred embodiment, as shown in FIGS. 3 and 4, the rotary drive comprises the magnet fastener as described above, the magnet 3 located in the accommodation section 12, and the sleeve 2 for accommodating the fastener 1. An annular groove 21 is provided on the inner periphery of the sleeve 2, and the deformable section 11 deforms radially outward to snap into the annular groove 21 when subjected to an axial force. The present invention is not limited to the specific material of the magnet 3, as long as it can achieve the corresponding functions. As mentioned above, in actual use, the magnet 3 is mainly subjected to a forward force, with relatively little or no backward force. In this regard, on the one hand, the magnet 3 can be fixed in the accommodation section 12 by interference fit, adhesive or the way of placing soft material between the magnet 3 and the accommodation section 12; on the other hand, as a preferred embodiment of the present invention, the annular deformable groove 15 provided on the outer periphery of the fastener 1 deforms radially inward to fix the magnet 3 when subjected to an axial force in a more secure manner. This design makes the rotary drive more durable. The structure and material of the sleeve 2 are not particularly specified, as long as the inner periphery of the sleeve 2 is provided with an annular groove 21 that matches the position and shape of the flange structure obtained after the deformable section 11 is stressed. As a preferred embodiment, by providing annular grooves 21 at corresponding parts of the inner periphery of the sleeve 2 that match the “barb-like structure” formed by the deformable section 11 after being axially stressed, the mutual cooperation between the two can make the fastener 1 better fixed in the sleeve 2.

As further shown in FIGS. 3 and 4, when the deformable section 11 is subjected to an axial force, in order to better achieve the radially outward deformation, as a preferred embodiment, the inner periphery of the sleeve 2 is provided with an annular slope 22 on the rear side of the annular groove 21, and the annular slope 22 inclines from outside to inside in a direction away from the annular groove 21 (the cross-sectional diameter is getting smaller and smaller). With this design, when the deformable section 11 is stressed, the rear part of the fastener 1 can be gathered toward the center under the action of the annular slope 22 to better form the “barb-like structure”. In order to achieve a good sliding effect between the rear end of the deformable section 11 and the annular slope 22, as a preferred example, as shown in FIGS. 1 and 3, the rear end of the deformable section 11 is provided with an annular chamfer 14. Before the deformable section 11 is subjected to an axial force, the angle of the annular chamfer 14 is less than or at most equal to the angle of the annular slope 22 (the acute angle formed between the two opposing inclined planes and the central axis 4).

As further shown in FIG. 2, in order to better fix the fastener 1 in the sleeve 2 and prevent the fastener 1 from relative rotation in the sleeve 2, as a preferred embodiment of the present invention, the fastener 1 is provided with a strip-shaped protruding structure 16 on the outer periphery thereof. The outer diameter of the cross-section of the strip-shaped convex structure 16 should be slightly larger than the inner diameter of the sleeve 2, so that there is an interference fit between the fastener 1 and the sleeve 2, thereby preventing relative rotation between the fastener 1 and the sleeve 2. The present invention is not limited to the specific length or position of the strip-shaped convex structure 16, as long as the corresponding functions can be achieved. In general, for the convenience of processing, it can be selected to provide strip-shaped convex structures 16 on the outer peripheries of both the deformable section 11 and the accommodation section 12, or to provide strip-shaped convex structures 16 only on the outer periphery of the deformable section 11.

As further shown in FIGS. 3 and 4, in a preferred embodiment, the outer peripheral structure on the front side of the magnet 3 matches the blocking mechanism 13. For example, when the blocking mechanism 13 has an annular inner chamfer structure, the outer periphery structure on the front side of the magnet 3 has a matching annular chamfer structure; when the blocking mechanism 13 is an annular flange structure, the outer periphery structure on the front side of the magnet 3 is a matching annular groove structure.

In addition, in order to avoid unwanted gaps between the magnet 3 and the magnetically attracted object (such as nuts, bolts or drill bits), through the matching design of the blocking mechanism 13 and the magnet 3, the present invention makes the front end surface of the magnet 3 flush with the front end surface of the fastener 1.

As further shown in FIGS. 1 and 2, in an example, the fastener 1 is provided with a step 17 at the outer periphery thereof between the blocking mechanism 13 and the accommodation section 12. For example, when the head of the bolt has a convex edge, the step 17 can accommodate the edge such that the magnet 3 can contact the head end surface of the bolt to provide greater magnetic attraction to hold the bolt.

In a third aspect of the present invention, there is provided a method for assembling a rotary drive. In a preferred embodiment, the assembly method uses a rotary drive without an annular deformable groove 15, comprising:
inserting the magnet 3 from the rear side of the fastener 1 and fixedly installing it into the accommodation section 12;
inserting the fastener 1 from the front side of the sleeve 2;
applying an axial force to the fastener 1 and pushing the fastener 1 to the rear end inside the sleeve 2;
further applying an axial force to the fastener 1, such that the deformable section 11 is deformed radially outward under the axial force and snaps into the annular groove 21.

As a preferred embodiment, the fixed installation is achieved by interference fit, adhesive or the way of placing soft material between the magnet 3 and the accommodation section 12.

The present invention provides another preferred embodiment of the method for assembling a rotary drive, which uses a rotary drive with an annular deformable groove 15, comprising:
inserting the magnet 3 from the rear side of the fastener 1 and fixedly installing it into the accommodation section 12;
inserting the fastener 1 from the front side of the sleeve 2;
applying an axial force to the fastener 1 and pushing the fastener 1 to the rear end inside the sleeve 2;
further applying an axial force to the fastener 1, such that the deformable section 11 is deformed radially outward under the axial force and snaps into the annular groove 21, and meanwhile such that the annular deformable groove 15 is deformed radially inward under the axial force to fix the magnet 3.

In order to achieve the function of driving rotary objects (such as nuts, bolts or drill bits) to rotate, a slot 23 is provided on the inner periphery of the front side of the sleeve 2. The structure of the slot 23 matches the structure of the rotary object. In general, if the connection structure of the nut, bolt or drill bit is hexagonal, the slot 23 is provided with a corresponding hexagonal structure. The present invention has no specific requirement on the depth of the slot 23, as long as it can achieve the corresponding functions. As a preferred embodiment, the rotary drive is a socket wrench (nut driver).

In order to realize the function of driving rotary objects (such as nuts, bolts or drill bits) to rotate, the rear side of the sleeve 2 is further provided with a driving connection part 24 for connecting with a driving mechanism. The present invention is not particularly limited to the structure of the driving connection part 24. For example, it may be a conventional connecting rod structure. The present invention is not particularly limited to the driving mechanism. For example, it may be a conventional driving device including an electric motor.

In general, the rotary objects (such as nuts, bolts or drill bits) often have different sizes or structures, so it is necessary to match the rotating drivers with corresponding sizes, and structures of the slot 23.

In a fourth aspect of the present invention, there is provided a rotary drive kit. In a preferred embodiment, the rotary drive kit includes a series of rotary drives as described above with different sizes and/or different structures of the slot 23. The specific sizes of the rotary drives, the structures of the slots 23, and the specific numbers of the rotary drives can be designed and adjusted correspondingly by those skilled in the art according to the actual requirements.

The above description of various embodiments of the present invention is provided for the purpose of illustration to those skilled in the art. It is not intended that the invention be exclusive or limited to a single disclosed embodiment. As taught above, many alternatives and modifications to the present invention would be apparent to those skilled in the art. Thus, while some alternative embodiments have been specifically described, other embodiments will be apparent to, or can be relatively readily developed by those skilled in the art. The present invention is intended to include all alternatives, modifications, and variations of the invention described herein, as well as other embodiments falling within the spirit and scope of the invention described above.

1. A magnet fastener comprising a deformable section, an accommodation section for accommodating a magnet, and a blocking mechanism in sequence from a rear side to a front side, wherein the blocking mechanism blocks the magnet from detaching from the front side, and the deformable section deforms radially outward when subjected to an axial force.

2. The magnet fastener of claim 1, wherein the deformable section has an axial cross-section of U-shaped, V-shaped or C-shaped structure with an opening facing a central axis.

3. The magnet fastener of claim 1, wherein the deformable section includes a first deformable section, a second deformable section and a third deformable section which are connected in sequence, wherein a front side of the first deformable section is connected to the accommodation section.

4. The magnet fastener of claim 3, wherein an inner diameter of the second deformable section is larger than an inner diameter of the accommodation section, and an inner diameter of the first deformable section gradually decreases from the second deformable section to the accommodation section; and an inner diameter of the third deformable section is smaller than the inner diameter of the second deformable section and is greater than or equal to the inner diameter of the accommodation section.

5. The magnet fastener of claim 1, wherein the fastener is made of a material which is a soft material, preferably aluminum, copper or plastic.

6. The magnet fastener of claim 1, wherein the outer periphery of the fastener is provided with an annular deformable groove between the deformable section and the accommodation section, and the annular deformable groove deforms radially inward to fix the magnet when subjected to an axial force.

7. The magnet fastener of claim 6, wherein a depth of the annular deformable groove is approximately half of a wall thickness of the accommodation section.

8. The magnet fastener of claim 1, wherein the blocking mechanism is an annular inner chamfer structure.

9. The magnet fastener of claim 1, wherein the blocking mechanism is an annular flange structure, and an inner diameter of the annular flange is smaller than an inner diameter of the accommodation section and a maximum diameter of the magnet.

10. The magnet fastener of claim 1, wherein an outer periphery of the fastener is provided with a strip-shaped convex structure.

11. A rotary drive, characterized by comprising the magnet fastener of claim 1, a magnet located in the accommodation section, and a sleeve for accommodating the fastener, wherein an inner periphery of the sleeve is provided with an annular groove, and the deformable section deforms radially outward to snap into the annular groove when subjected to an axial force.

12. The rotary drive of claim 11, wherein the inner periphery of the sleeve is provided with an annular slope behind the annular groove, and the annular slope inclines from outside to inside in a direction away from the annular groove.

13. The rotary drive of claim 11, wherein a rear end of the deformable section is provided with an annular chamfer, and the angle of the annular chamfer is less than or equal to the angle of the annular slope before the deformable section is subjected to an axial force.

14. The rotary drive of claim 11, wherein an outer periphery structure of a front end of the magnet matches the blocking mechanism.

15. The rotary drive of claim 11, wherein a front end surface of the magnet is flush with a front end surface of the fastener.

16. The rotary drive of claim 11, wherein the fastener is provided with a step at an outer periphery thereof between the blocking mechanism and the accommodation section.

17. The rotary drive of claim 11, characterized in that the inner periphery of a front side of the sleeve is provided with a slot for driving a rotary object to rotate.

18. The rotary drive of claim 17, wherein the rotary object is a nut, a bolt or a drill bit.

19. The rotary drive of claim 11, wherein a rear side of the sleeve is provided with a driving connection part for connecting with a driving mechanism.

20. The rotary drive of claim 11, wherein the rotary drive is a socket wrench.

21. A method for assembling a rotary drive, the rotary drive comprising a fastener, a sleeve and a magnet, the fastener being provided with a deformable section and an accommodation section, an inner periphery of the sleeve being provided with an annular groove, the method comprising the following steps:
inserting the magnet from a rear side of the fastener and fixedly installing the magnet into the accommodation section;
inserting the fastener from a front side of the sleeve;
applying an axial force to the fastener and pushing the fastener to a rear end inside the sleeve;
further applying an axial force to the fastener, such that the deformable section is deformed radially outward under the axial force and snaps into the annular groove.

22. The method of claim 21 for assembling a rotary drive, wherein a fixed installation is achieved by interference fit, adhesive or the way of placing soft material between the magnet and the accommodation section.

23. The method of claim 21 for assembling a rotary drive, wherein an outer periphery of the fastener is further provided with an annular deformable groove between the deformable section and the accommodation section.

24. The method of claim 21 for assembling a rotary drive, wherein further applying the axial force to the fastener, such that the deformable section is deformed radially outward under the axial force and snaps into the annular groove, includes further applying the axial force to the fastener, such that the annular deformable groove is deformed radially inward under the axial force to fix the magnet.
